(19) United States
(12) Patent Application Publication
(10) Pub. No.: US 2010/0202390 A1
(43) Pub. Date: Aug. 12, 2010

(54) MOBILE BROADCAST SYSTEM FOR SUPPORTING IRREGULAR INTERVAL BROADCAST SERVICE AND IN-BAND SIGNALING METHOD AND APPARATUS THEREFOR

(75) Inventors: Yeon Ju LIM, Seoul (KR); Jae Yoel KIM, Suwon-si (KR); Sung Ryul YUN, Suwon-si (KR); Hak Ju LEE, Incheon Metropolitan City (KR); Se Ho MYUNG, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/700,304

(22) Filed: Feb. 4, 2010

(30) Foreign Application Priority Data
Feb. 6, 2009 (KR) 10-2009-0009665

(51) Int. Cl. H04W 72/12

(52) U.S. Cl. 370/329

(57) ABSTRACT

An in-band signaling method and apparatus of a mobile broadcast system supporting irregular interval broadcast services is provided for facilitating channel switching of a mobile device. An in-band signaling method for a mobile broadcast system according to the present invention includes generating scheduling information of Physical Layer Pipes (PLPs) transmitted at irregular intervals, the scheduling information including a next frame index and a first frame flag, inserting the scheduling information into a control information of a current frame and multiplexing broadcast service traffic of the PLPs and the control information.

### PRIORITY

This application claims the benefit under 35 U.S.C. §119(a) of a Korean patent application filed on Feb. 6, 2009 in the Korean Intellectual Property Office and assigned serial No. 10-2009-0009665, the entire disclosure of which is hereby incorporated by reference.

### BACKGROUND OF THE INVENTION

1. Field of the Invention

The present invention relates to a mobile broadcast system. More particularly, the present invention relates to an in-band signaling method and apparatus of a mobile broadcast system supporting irregular interval broadcast services for facilitating channel switching of a mobile device.

2. Description of the Related Art

In the 21^{st} century information society, broadcast services are focused on digitalization, multi-channelization, broadband, and high quality requirements. With the widespread use of high resolution digital televisions, Portable Multimedia Players (PMPs), and other mobile broadcast devices, there are requirements for simultaneous distribution of the content in different formats to suit different devices and users.

Digital Video Broadcasting-Terrestrial 2 (DVB-T2) has been recently standardized (as the second generation European terrestrial digital broadcast standard) to meet the requirements for supporting both fixed and mobile receivers. Also, a next generation DVB standard for supporting mobility of mobile devices has been established under the title of the DVB Next Generation Handheld (DVB-NGH) standard. The DVB-NGH is anticipated to be developed on the basis of the physical layer of DVB-T2 (which supports various channel environments and system parameter modes) rather than the DVB-H (which is the first mobile broadcast standard) with the added support for mobility. Since the power consumption of the broadcast receivers (i.e., mobile devices) is one of the main issues in the systems supporting mobility, there is an incentive for the broadcast station not to transmit the broadcast service in every frame.

In such a physical layer structure, the control channel transmits control information on the transmission scheme of the physical layer. Assuming that the signal is transmitted in a unit of a frame, each frame consists of multiple broadcast service channels and a control channel carrying the information including service indices, positions in the frame, modulation scheme and coding rate, cell ID, etc. The control channel can be transmitted in every frame symbol separately from the data channel or in an in-band signaling format (dynamic scheduling information varying every frame) on the data channel in every frame.

The broadcast services (Physical Layer Pipes (PLPs)) are transmitted to the broadcast receivers on the traffic channel at a regular interval. In the meantime, the non-delay sensitive packet data, which is not effected by a relatively long delay, can be transmitted at irregular intervals. That is, the next generation terrestrial mobile broadcast system should be developed in consideration of the PLPs transmitting at both the regular and irregular intervals.

In the broadcast system of the related art, the PLPs are transmitted at a regular interval whereas the individual PLPs can be transmitted at different time intervals. Accordingly, in order for a broadcast receiver to receive a PLP, it is required to provide the receiver with the control information about the frame on which the PLP is transmitted as well as the control information on the modulation scheme/coding rate required for the target PLP and scheduling information indicating the position of the target PLP in the frame (in the dynamic information part of the P2 preamble since the scheduling information is changed in every frame). For this purpose, the configurable information part of the P2 preamble includes information fields such as START_FRAME_IDX, P_{I}, I_{JUMP}. The configurable information part carries the control information that is not changed in every frame.

Here, the START_FRAME_IDX is the index of the frame in which the corresponding PLP is transmitted first within a subframe consisting of multiple frames, P_{I} is a number of frames to which each Interleaving Frame (IF) is mapped, and I_{JUMP} is the difference in a frame index between successive frames to which a particular PLP is mapped. For instance, if the PLP is transmitted in every frame, the I_{JUMP} value is 1, and (P_{I}) is 1.

FIG. 1 is a diagram illustrating initial broadcast service reception and channel switching to a target service in a broadcast system according to the related art.

Referring to FIG. 1, reference numerals 111 to 119 denote PLPs transmitted at a regular interval (hereinafter called regular PLP), and reference numerals 132 to 136 denote PLPs transmitted at irregular intervals (hereinafter called irregular PLP). In the case where the receiver initially accesses the system at the time point between the frame carrying the regular PLP 111 and the frame carrying the regular PLP 113 to receive the irregular PLP 132, the receiver performs P2 demodulation on every frame and starts traffic modulation on the irregular PLP 132 having the scheduling information set to a non-zero value for the corresponding PLP. However, since the PI of the irregular PLP 132 is 2, the frame carrying the irregular PLP 132 is the second frame of the IF such that it is impossible to demodulate the IF successfully only with the frame carrying the irregular PLP 132.

In the case where the receiver switches the channel to the irregular target PLP 134 at the time point between the frame carrying the regular PLP 115 and the frame carrying the irregular target PLP 134, the current PLP does not have the scheduling information about the target PLP 134 transmitted at an irregular interval, such that the receiver attempts to receive the P2 of the frame right after the frame at which the channel switching has occurred. In this case, the receiver continues the P2 modulation attempt until the frame carrying the target PLP 134 is received. This means that the receiver can receive the target PLP 134 after the receipt of the scheduling information set to a non-zero value in the frame carrying the target PLP 134. Although the receiver has received scheduling information on the target PLP, the receiver does not know the position of the next frame carrying the target PLP and thus continues P2 modulation for every frame until the frame 136 carrying the irregular PLP.

In order for the receiver to receive the irregular PLP in the above structured conventional broadcast system, the receiver must attempt the P2 preamble modulation to every frame until the irregular PLP is received since it does not know the position of the frame carrying the irregular PLP. Even when the irregular PLP is received, if the frame carrying the irregular PLP is not the first frame mapped to the IF, the P2 demodulation cannot be used. That is, since the current PLP has no information on the target PLP transmitted at the irregular interval, the receiver must perform the P2 demodulation continuously until the target PLP is received for channel switching to the target PLP. Furthermore, if the target PLP received after the channel switching is not carried by the first frame mapped to the IF, the receiver performs demodulation on the PLP unnecessarily.

### SUMMARY OF THE INVENTION

An aspect of the present invention is to address at least the above mentioned problems and/or disadvantages and to provide at least the advantages described below. Accordingly, an aspect of the present invention is to provide a frame structure (P2 preamble of the frame) for supporting irregular Physical Layer Pipes (PLP)s and a method and apparatus for facilitating channel switching between a broadcast service transmitted at a regular interval and a broadcast service transmitted at an irregular interval.

Also, an aspect of the present invention is to provide a frame structure for supporting irregular PLPs and a method and apparatus for facilitating channel switching between the regular and irregular PLPs by using an in-band signaling mechanism.

In accordance with an aspect of the present invention, a control information delivery method for a mobile broadcast system is provided. The method includes generating scheduling information of PLPs transmitted at irregular intervals, the scheduling information including a next frame index and a first frame flag, inserting the scheduling information into control information of a current frame, and multiplexing broadcast service traffic of the PLPs and the control information.

In accordance with another aspect of the present invention, a system access method of a receiver in a mobile broadcast system is provided. The method includes receiving a frame carrying broadcast service traffic, extracting control information from the frame, the control information including a next frame index and an initial frame flag, analyzing the initial frame flag, jumping, if the frame is not the initial frame based on the analysis result, to a next frame indicated by the next frame index to analyze the initial frame flag, and processing, if the frame is the initial frame based on the analysis result, the broadcast service traffic in the frame.

In accordance with yet another aspect of the present invention, a control information delivery method for a mobile broadcast system is provided. The method includes generating in-band control information of PLPs for channel switching, multiplexing broadcast service traffic of a current PLP and the in-band control information into a frame, generating control information including a next frame index and an initial frame flag for the PLPs transmitted at irregular intervals; multiplexing the broadcast service traffic of the PLPs and the control information into the frame, and transmitting the frame.

In accordance with still another aspect of the present invention, a mobile broadcast system including a transmitter and a receiver is provided. The transmitter includes a service traffic generator for generating broadcast service traffic, a control information generator for generating control information of PLPs transmitted at irregular intervals, the control information including a next frame index and an initial frame flag, a frame generator for generating frames by multiplexing the broadcast service traffic of the PLPs and the control information, and a frame transmitter for transmitting the frames.

In accordance with another aspect of the present invention, a transmitter apparatus of a mobile broadcast system is provided. The apparatus includes a service traffic generator for generating broadcast service traffic, an in-band control information generator for generating in-band control information as the control information of a target PLP for a channel switching, a service traffic configurator for configuring the broadcast service traffic by inserting the in-band control information, a control information generator for generating control information of PLPs transmitted at irregular intervals, the control information including a next frame index and an initial frame flag, a frame generator for generating frames by multiplexing the broadcast service traffic output by the service traffic generator and the control information output by the control information generator, and a frame transmitter for transmitting the frames, wherein the transmitter generates the control signal of the target PLP for the channel switching, transmits the frame containing the broadcast service traffic of the current PLP and the control information as in-band signaling control information, generates the control information including the next frame index and the initial frame flag about the PLPs transmitted at irregular intervals, and transmits the frame containing the broadcast service traffic of the corresponding PLPs and the control information.

In accordance with still another aspect of the present invention, a receiver apparatus of a mobile broadcast system is provided. The apparatus includes a channel switching detector for detecting a channel switching event, an in-band control information extractor for receiving a frame containing a broadcast traffic of a current PLP having control information of target PLP, for extracting the control information of the target PLP from the received frame, and for waiting for the frame indicated by a next frame index included in the control information acquired through the in-band signaling, a control information demodulator for receiving the frame carrying the target PLP and indicated by the next frame index, and for demodulating the control information in the corresponding frame to extract the next frame index and an initial frame flag, a service reception controller for waiting until the control information demodulator demodulates a next frame indicated by the next frame index if the frame is not an initial frame among the frames carrying the corresponding PLP, and for controlling demodulation of the broadcast service traffic in the frame which is indicated by the initial frame flag as the initial frame among the frames carrying the corresponding PLP, and a service demodulator for demodulating the broadcast service traffic under the control of the service reception controller.

In accordance with still another aspect of the present invention, a mobile broadcast system is provided. The system includes a transmitter and a receiver. The transmitter includes a service traffic generator for generating broadcast service traffic, an in-band control information generator for generating in-band control information as the control information of a target PLP for a channel switching, a service traffic configurator for configuring the broadcast service traffic by inserting the in-band control information, a control information generator for generating control information of PLPs transmitted at irregular intervals, the control information including a next frame index and an initial frame flag, a frame generator for generating frames by multiplexing the broadcast service traffic output by the service traffic generator and the control information output by the control information generator, and a frame transmitter for transmitting the frames, wherein the transmitter generates the control signal of the target PLP for the channel switching, transmits the frame containing the broadcast service traffic of the current PLP and the control information as in-band signaling control information, generates the control information including the next frame index and the initial frame flag about the PLPs transmitted at irregular intervals, and transmits the frame containing the broadcast service traffic of the corresponding PLPs and the control information. The receiver includes a channel switching detector for detecting a channel switching event, an in-band control information extractor for receiving a frame containing a broadcast traffic of a current PLP having control information of target PLP, for extracting the control information of the target PLP from the received frame, and for waiting for the frame indicated by a next frame index included in the control information acquired through the in-band signaling, a control information demodulator for receiving the frame carrying the target PLP and indicated by the next frame index, and for demodulating the control information in the corresponding frame to extract the next frame index and an initial frame flag, a service reception controller for waiting until the control information demodulator demodulates a next frame indicated by the next frame index if the frame is not an initial frame among the frames carrying the corresponding PLP, and for controlling demodulation of the broadcast service traffic in the frame which is indicated by the initial frame flag as the initial frame among the frames carrying the corresponding PLP, and a service demodulator for demodulating the broadcast service traffic under the control of the service reception controller.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating initial broadcast service reception and channel switching to a target service in a broadcast system according to the related art;

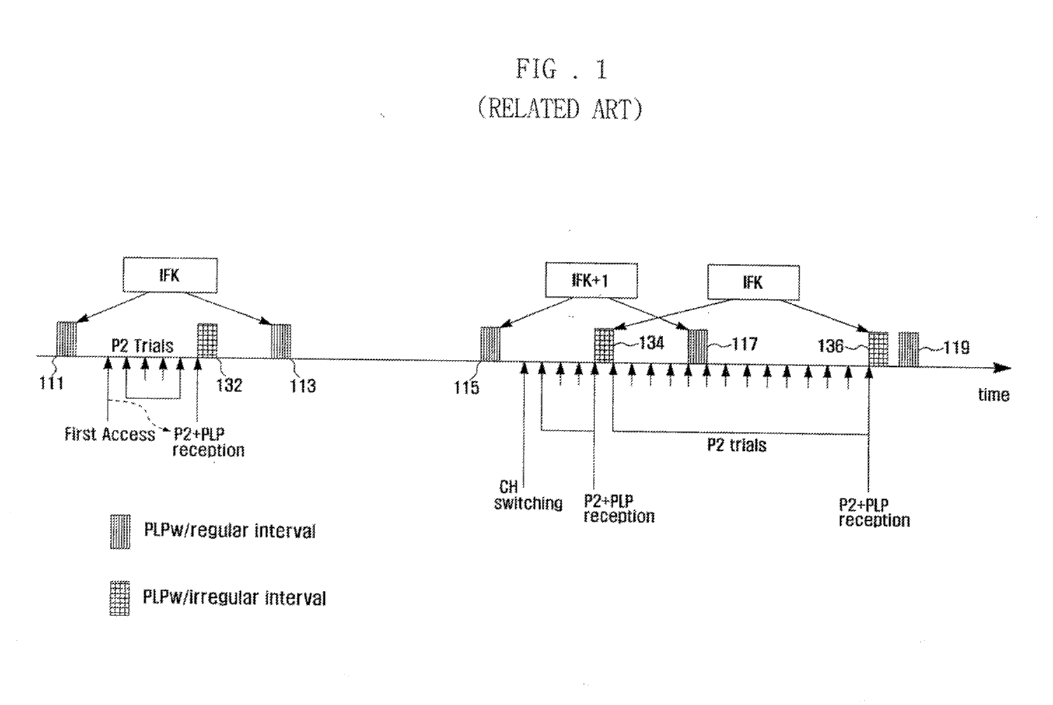

FIG. 2 is a diagram illustrating transmission of a broadcast service at an irregular interval with a P2 preamble in a broadcast system according to an exemplary embodiment of the present invention;

FIG. 3 is a diagram illustrating channel switching to a broadcast service transmitted at irregular intervals in a broadcast system according to an exemplary embodiment of the present invention;

FIG. 4 is a diagram illustrating channel switching to a broadcast service transmitted at irregular intervals in a broadcast system according to an exemplary embodiment of the present invention;

FIG. 5 is a flowchart illustrating a P2 preamble transmission procedure of a transmitter in a mobile broadcast system supporting the irregular interval broadcast service according to an exemplary embodiment of the present invention;

FIG. 6 is a flowchart illustrating an initial service access procedure of a broadcast receiver in a mobile broadcast system supporting the irregular interval broadcast service according to an exemplary embodiment of the present invention;

FIG. 7 is a flowchart illustrating an in-band signaling procedure of a transmitter for supporting channel switching in a mobile broadcast system supporting the irregular interval broadcast service according to an exemplary embodiment of the present invention;

FIG. 8 is a flowchart illustrating a channel switching procedure of a receiver using the in-band signaling in a mobile broadcast system supporting the irregular interval broadcast service according to an exemplary embodiment of the present invention;

FIG. 9 is a flowchart illustrating a channel switching procedure of a receiver using the in-band signaling in a mobile broadcast system supporting the irregular interval broadcast service according to an exemplary embodiment of the present invention;

FIG. 10 is a block diagram illustrating a configuration of a transmitter for transmitting broadcast service traffic with control information (P2 preamble) in a mobile broadcast system supporting the irregular interval broadcast service according to an exemplary embodiment of the present invention;

FIG. 11 is a block diagram illustrating a configuration of a receiver for receiving the broadcast service traffic with control information (P2 preamble) in a mobile broadcast system supporting the irregular interval broadcast service according to an exemplary embodiment of the present invention;

FIG. 12 is a block diagram illustrating a configuration of a transmitter for transmitting broadcast service traffic with in-band control information in a mobile broadcast system supporting the irregular interval broadcast service according to an exemplary embodiment of the present invention;

FIG. 13 is a diagram illustrating a configuration of a receiver for receiving the broadcast traffic with in-band control information in a mobile broadcast system supporting the irregular interval broadcast service according to an exemplary embodiment of the present invention; and

FIG. 14 is a block diagram illustrating a configuration of a receiver for receiving the broadcast traffic with in-band control information in a mobile broadcast system supporting the irregular interval broadcast service according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a signaling mechanism for supporting the broadcast service transmitted at an irregular interval and an in-band signaling method and apparatus for facilitating the same in a mobile broadcast system. In order to support both the broadcast service transmitted at a regular interval and the broadcast service transmitted at an irregular interval, a new control information structure is proposed. In an exemplary embodiment of the present invention, the control information can be transmitted independently or along with the service traffic. The control information can be structured differently according to the broadcast technology. The control information can be transmitted in a P2 preamble in a Digital Video Broadcasting (DVB) system, a Layer-1 signaling channel in other broadcast systems, and a transmission parameter channel in other communication systems. The following description is directed to the P2 preamble signaling in the DVB system for supporting the broadcast services transmitted at regular and irregular intervals. In the case where more than one physical frame is mapped to each Interleaving Frame (IF), the signaling information of the control channel includes an indicator indicating the presence of the first frame. Informing the broadcast receiver of whether the next frame carrying the target broadcast service is the first frame mapped to the interleaving frame facilitates channel switching channels.

In the following description, the term “control information” denotes the information for scheduling the regular and irregular Physical Layer Pipes (PLPs) and can be the P2 signals in a DVB system. In an exemplary embodiment of the present invention, the control information includes a next frame index (NEXT_FRAME_IDX) informing of the next frame carrying the current PLP and an IF's frame flag (IF_FIRST_FRAME_FLG) informing that the current frame is the first frame among the frames mapped to the IF. Also, the terms “in-band control information” and “target PLP control information” denote the in-band signaling information configured when generating broadcast service traffic and can be used for indicating the control information such as a target PLP location in a channel switching process. In an exemplary embodiment of the present invention, the in-band control information includes the NEXT_FRAME_IDX of the target PLP. In an exemplary embodiment of the present invention, the in-band control information includes the NEXT_FRAME_IDX and IF_FIRST_FRAME_FLAG.

In an exemplary embodiment of the present invention, a P2 preamble structure for supporting a broadcast service transmitted at an irregular interval is proposed. The P2 preamble is a control channel of the DVB system and includes various control information fields. As aforementioned, the I_{JUMP} is transmitted in the configurable information part of the P2 preamble. In the case where the I_{JUMP} of the PLP is set to 0, this indicates that the PLP is transmitted at irregular intervals. The dynamic control information part carrying the control information fields of which values are changed every frame can be divided into two regions containing the information on the regular PLPs and irregular PLPs. The two regions have the scheduling information on the current frame carrying the PLPs in common. The dynamic control information of the P2 preamble for the irregular PLPs is described in Table 1.

TABLE 1

| | |
|---|---|
| Field | Size |

For i=0, NUM_PLP-1 {

| | | |
|---|---|---|
| PLP_ID | 8 | bits |
| PLP_START | 22 | bits |
| PLP_NUM_BLOCKS | 10 | bits |

| | | |
|---|---|---|
| NEXT_FRAME_IDX | 8 | bits |
| IF_FIRST_FRAME_FLAG | 1 | bit |

| | | |
|---|---|---|
| RESERVED_2 | 16 | bits |

}

In Table 1, the NEXT_FRAME_IDX indicates the index of the next frame carrying the current PLP and can be expressed as the number of frames between the current frame and the next frame carrying the current PLP. The IF_FIRST_FRAME_FLAG is a flag indicating that the current frame is the first frame among the frames mapped to the IF. For instance, the IF_FIRST_FRAME_FLAG can be a 1 bit flag and set to 0 for indicating the first frame or 1 for the frames other than the first frame in the IF.

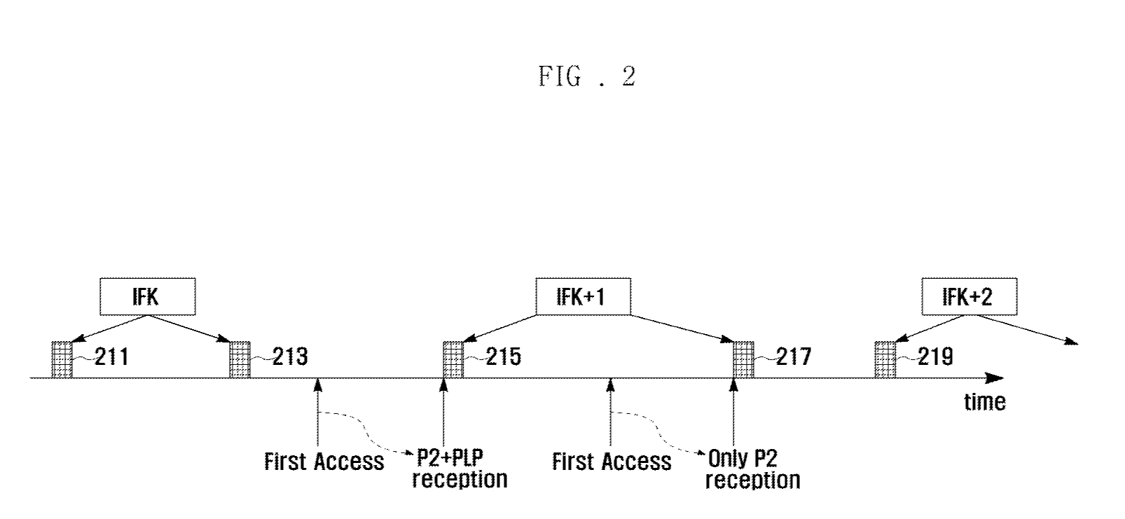

FIG. 2 is a diagram illustrating transmission of a broadcast service at an irregular interval with a P2 preamble in a broadcast system according to an exemplary embodiment of the present invention.

Referring to FIG. 2, reference numerals 211 to 219 denote the frames carrying the irregular PLPs, and these frames are interposed between other frames carrying regular PLPs. The description is made under the assumption that the PI of the irregular PLP is 2. If the receiver accesses the system to receive the service at the time point between the frames 213 and 215, it acquires the dynamic control information (as described in Table 1) from the P2 of the frame received first. The receiver checks the scheduling information set to 0 and thus recognizes that the frame does not carry the service. In this case, the receiver checks the NEXT_FRAME_IDX and recognizes that the next frame carrying the PLP is the frame 215. Since the frame 215 is the first frame among the frames mapped to the IF, the IF_FIRST_FRAME_FLAG is set to 0. Accordingly, the receiver performs demodulation on the PLP carried by the frame 215 using the scheduling information. Next, the receiver checks the NEXT_FRAME_IDX of the P2 of the frame 215 to recognize that the next frame carrying the target PLP is the frame 217.

If the receiver accesses the system to receive the service at the time point between the frames 213 and 215, it acquires and demodulates the P2 of the frame received first and acquires the scheduling information set to 0. In this case, the receiver checks the NEXT_FRAME_IDX of the frame and recognizes that the next frame carrying PLP is the frame 217. Since the frame 217 is not the first frame among the frames mapped to the IF, the IF_FIRST_FRAME_FLAG is set to 1. Accordingly, the receiver recognizes that the frame 217 is not the first frame and thus does not perform demodulation on the service traffic of the frame 217. This is because the entire IF cannot be decoded successfully without the first frame. Accordingly, the receiver checks the NEXT_FRAME_IDX of the P2 and receives the frame 219 based on the value of the NEXT_FRAME_IDX.

If the IF_FIRST_FRAME_FLAG information is not used and the receiver accesses the system to receive the service at the time point after the first frame among the frames mapped IF, it performs demodulation on the PLP carried by the frame of which scheduling information is set to a non-zero value (e.g., frame 217) without the first frame of the IF. In this case, the PLP carried by the frame is useless. Although the description is made under the assumption of P_{I}=2, when the P_{I} is 4 or 8, the receiver may receive the PLPs carried by up to 3 or 8 useless frames in respective cases, thereby wasting power for demodulating the useless PLPs.

Table 2 shows signal information configured for supporting channel switching and two or more PLPs according to an exemplary embodiment of the present invention. The channel switching from a PLP transmitted at a regular interval (regular PLP) to a PLP transmitted at an irregular interval (irregular PLP) can be implemented with a constraint in which the current regular PLP includes the control information about other target PLPs, as many as the number indicated by NUM_OTHER_PLP_IN_BAND only when the current PLP has a P_{I}*I_{JUMP} value that is less than a predefined value. P_{I}*I_{JUMP} denotes the total time required for receiving all the frames mapped to each IF where the time is counted in a unit of a frame. For instance, if the channel switching occurs in the middle of receiving the current PLP of which P_{I}=2 and I_{JUMP}=2 with the in-band signaling, the receiver must receive both of the two frames mapped to each IF and the frames are transmitted every two frames, and thus it takes the time of total P_{I}*I_{JUMP}=4 frames for receiving the two frames carrying the PLP.

In Table 2, the NEXT_FRAME_IDX is the same parameter as the dynamic control information of the P2 preamble proposed in exemplary embodiments of the present invention, and thus may be interpreted identically. That is, NEXT_FRAME_IDX indicates the next frame index (or the number of frames between the current frame and the next frame carrying the target PLP) as the P2 preamble. At this time, the PLP_START and PLP_NUM_BLOCKS of the PLP transmitted at irregular intervals represent the scheduling information in the frame indicated by the NEXT_FRAME_IDX rather than the next frame. In the case where the PI of the target PLP is greater than 2, the frame indicated by the NEXT_FRAME_IDX may be the first frame among the frames mapped to each IF.

TABLE 2

| | |
|---|---|
| Field | Size |

For i=0, NUM_OTHER_PLP_IN_BAND-1
{

| | |
|---|---|
| PLP_ID | 8 bits |
| PLP_START | 22 bits |
| PLP_NUM_BLOCK | 10 bits |
| NEXT_FRAME_IDX | 8 bits |
| RESERVED_2 | 8 bits |

}

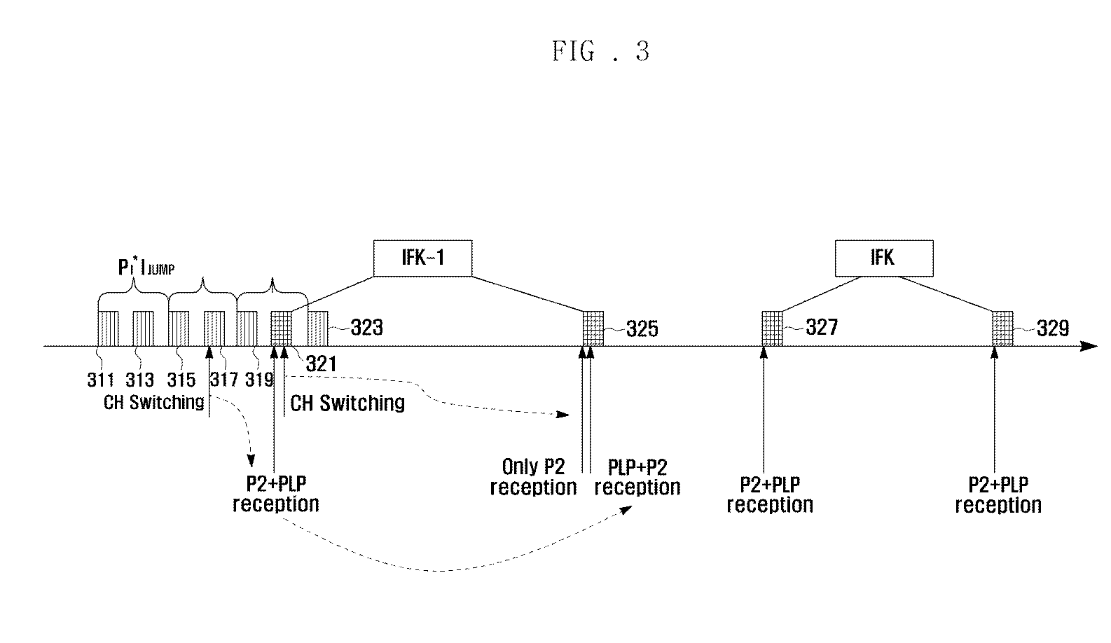

FIG. 3 is a diagram illustrating channel switching to a broadcast service transmitted at irregular intervals in a broadcast system according to an exemplary embodiment of the present invention.

Referring to FIG. 3, reference numerals 321 and 325 to 329 denote the frames carrying the target PLP, and reference numerals 311 to 319 and 323 denotes the frames carrying the current PLP. In FIG. 3, the current PLP is configured with P_{I}=2 and I_{JUMP}=2 such that it takes P_{I}*I_{JUMP}=4 to receive the 2 frames mapped to each IF. The frame 321 carries the current PLP and the target PLP.

If the channel switching occurs in the middle of receiving the frame 317, the receiver receives the frame 317 completely to demodulate the service corresponding to the IF mapped to the frames including the frame 315 which has been already demodulated and acquires the in-band signaling information transmitted through the frames 315 and 317 mapped to the single IF. As a consequence, the receiver checks the NEXT_FRAME_IDX and receives the frame 321 carrying the target PLP based on the value of the NEXT_FRAME_IDX. The receiver demodulates the P2 of the frame 321 to check the IF_FIRST_FRAME_FLAG and receives the target PLP based on the IF_FIRST_FRAME_FLAG set to 0. Also, the receiver waits for the next frame 325 carrying the target PLP by referencing the NEXT_FRAME_IDX acquired from the P2 of the frame 321 and demodulates the P2 and service carried by the frame 325.

If the channel switching occurs in the middle of receiving the frame 321, the receiver continues receiving the service to the frame 321 to acquire the NEXT_FRAME_IDX since the frame 319 and 321 are mapped to the same IF. As a consequence, the receiver recognizes the next frame 325 carrying the target PLP by referencing the NEXT_FRAME_IDX. Since the IF_FIRST_FRAME_FLAG value acquired by demodulating the P2 of the frame 325 is 1 (that is, since the frame 325 is not the first frame among the frames mapped to the IF, the IF_FIRST_FRAME_FLAG is set to 1), the receiver does not demodulate the target frame in the frame 325. In this case, the receiver checks the NEXT_FRAME_IDX acquired by demodulating the P2 and receives the next frame 327 carrying the target PLP. Since the frame 327 is the first frame among the frames mapped to the IF, the receiver performs demodulation on the P2 and service traffic carried in the frame 327.

Table 3 shows the in-band signaling information for supporting channel switching and two or more PLPs according to an exemplary embodiment of the present invention. In Table 3, the NEXT_FRAME_IDX represents the location information of the frames carrying the target PLP, as many as P_{I}. Also, the IF_FIRST_FRAME_FLAG indicates whether the frame is the first frame among the P_{I} frames mapped to the IF. If the NEXT_FRAME_IDX indicates the location information of the P_{I} frames mapped to the IF, there is no need to use an additional indicator for indicating the first frame. In this case the IF_FIRST_FRAME_FLAG field can be omitted.

TABLE 3

| | |
|---|---|
| Field | Size |

For i=0, NUM_OTHER_PLP_IN_BAN
D-1 { For j=0, P_{I}-1 {

| | | |
|---|---|---|
| PLP_ID | 8 | bits |
| PLP_START | 22 | bits |
| PLP_NUM_BLOCKS | 10 | bits |
| NEXT_FRAME_IDX | 8 | bits |
| RESERVED_3 } | 8 | bits |
| IF_FIRST_FRAME_FLG | 1 | bit |

}

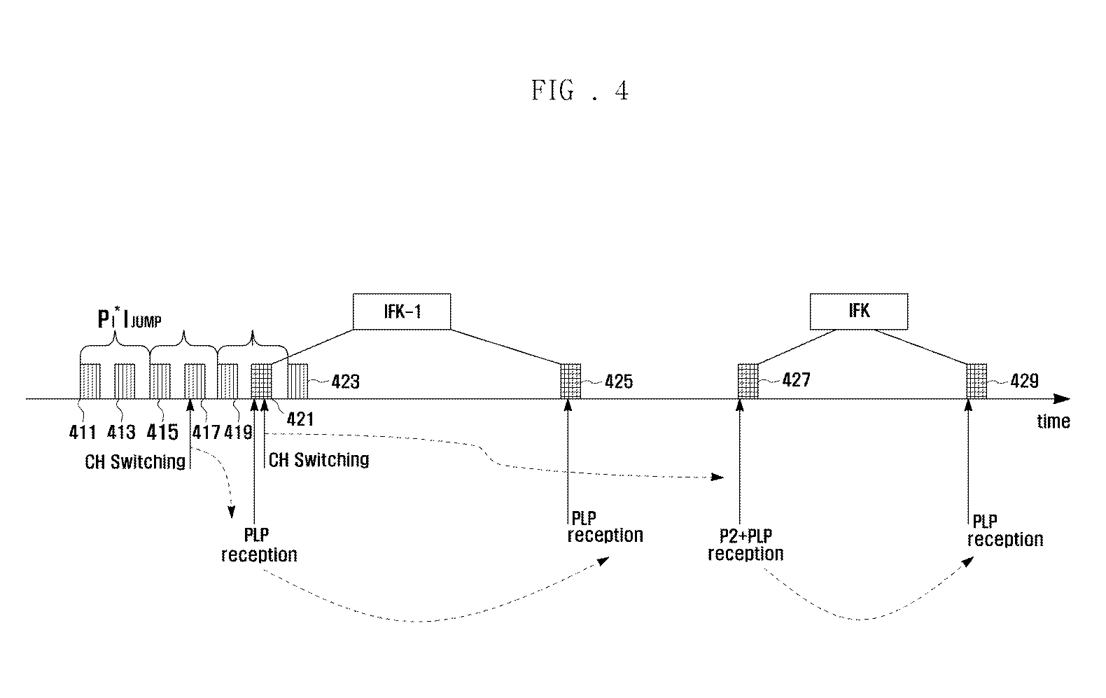

FIG. 4 is a diagram illustrating channel switching to a broadcast service transmitted at irregular intervals in a broadcast system according to an exemplary embodiment of the present invention.

Referring to FIG. 4, reference numerals 421 and 425 to 429 denote the frames carrying the target PLP, and reference numerals 411 to 419 and 423 denotes the frames carrying the current PLP. If the channel switching occurs in the middle of receiving the frame 417, the receiver receives the frame 417 completely to modulate the service corresponding to the IF mapped to the frames including the frame 415 which has already been demodulated and acquires the in-band signal information transmitted through the frames 415 and 417. As a consequence, the receiver acquires the NEXT_FRAME_IDX values indicating the location information of the frames 421 and 425 carrying the target PLP and the IF_FIRST_FRAME_FLAG indicating whether the frame 421 is the first frame among the frames mapped to the IF. Since the IF_FIRST_FRAME_FLAG value is 0, the receiver demodulates the target PLP from the frames 421 and 425 and acquires the next frames carrying the target PLP, i.e., the frames 427 and 429.

If the channel switching occurs in the middle of receiving the frame 421, the receiver receives the frame 421 completely since the frame 419 and 421 are mapped to the IF. As a consequence, the receiver acquires the NEXT_FRAME_IDX values indicating the frames 425 and 427 carrying the target PLP and the IF_FIRST_FRAME_FLAG value. At this time, the IF_FIRST_FRAME_FLAG value is 1 since the frame 425 is not the first frame among the frames mapped to the IF. Accordingly, the receiver waits for receiving the frame 427. The receiver demodulates the P2 of the frame 427, checks if the IF_FIRST_FRAME_FLAG set to 0 so as to demodulate the target PLP from the frame 427, and receives the next frame 429 carrying the target PLP by referencing the NEXT_FRAME_IDX acquired by demodulating the P2 of the frame 427.

By adopting the in-band signaling mechanism according to an exemplary embodiment of the present invention, the receiver performs demodulation on the P2 of the one or more frames indicated by the NEXT_FRAME_IDX rather than every frame. By adopting the in-band signaling mechanism according to an exemplary embodiment of the present invention, when the first frame among the multiple frames indicated by the NEXT_FRAME_IDX is not the first frame among the frames mapped to the IF, the receiver needs to demodulate the P2 of the frames other than the first frame among the multiple frames indicated by the NEXT_FRAME_IDX. For instance, when P_{I} is 2 as in the exemplary case of FIG. 4, the receiver demodulates only the P2 of the frame 427.

In an exemplary embodiment of the present invention, the channel switching can be processed only with the dynamic control information of the P2 rather than using the in-band signal mechanisms as described above. Unlike the in-band signaling based channel switching methods in which all the frames mapped to the current IF are received completely, the dynamic control information-based channel switching method performs decoding on the P2 of the frame right after the frame in which the channel switching occurs to acquire the location information of the next frame carrying the target PLP and jumps to the corresponding frame. Next, the receiver determines whether to receive the target PLP of the corresponding frame according to the IF_FIRST_FRAME_FLAG value acquired by demodulating the P2 of the corresponding frame and jumps to the next frame carrying the target PLP by referencing the NEXT_FRAME_IDX value to repeat the P2 modulation.

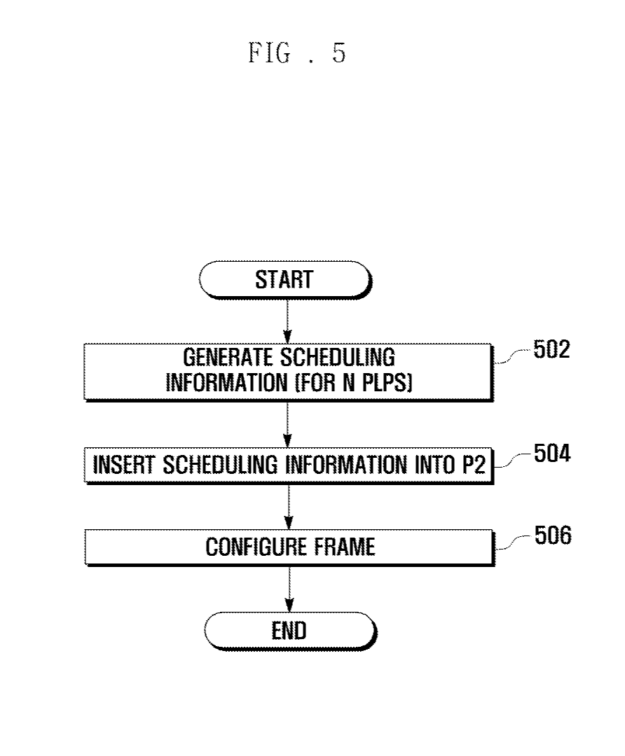

FIG. 5 is a flowchart illustrating a P2 preamble transmission procedure of a transmitter in a mobile broadcast system supporting the irregular interval broadcast service according to an exemplary embodiment of the present invention.

Referring to FIG. 5, the transmitter generates scheduling information about N PLPs in the current frame in step 502. At this time, the scheduling information of the irregular PLPs includes the NEXT_FRAME_IDX and IF_FIRST_FRAME_FLAG as described with reference to Table 1. The NEXT_FRAME_IDX is the index indicating the next frame carrying the current PLP (or the number of frames between the current frame and the next frame carrying the corresponding PLP), and the IF_FIRST_FRAME_FLAG is an flag indicating whether the current frame is the first frame among the frames mapped to the IF. Once the scheduling information has been generated, the transmitter inserts the scheduling information of the N PLPs into the control information of the current frame in step 504. Here, the control information can be the P2 preamble. In an exemplary embodiment of the present invention, the P2 preamble includes the NEXT_FRAME_IDX and IF_FIRST_FRAME_FLAG. Next, the transmitter multiplexes the broadcast service traffic and the control information into the frame and transmits the frame in step 506.

In short, the transmitter generates the scheduling information of the PLPs transmitted at irregular intervals, the scheduling including the NEXT_FRAME_IDX and IF_FIRST_FRAME_FLAG, inserts the scheduling information of the PLPs into the control information of the current frame, and multiplexes the broadcast service traffic and the control information into the frame to be transmitted.

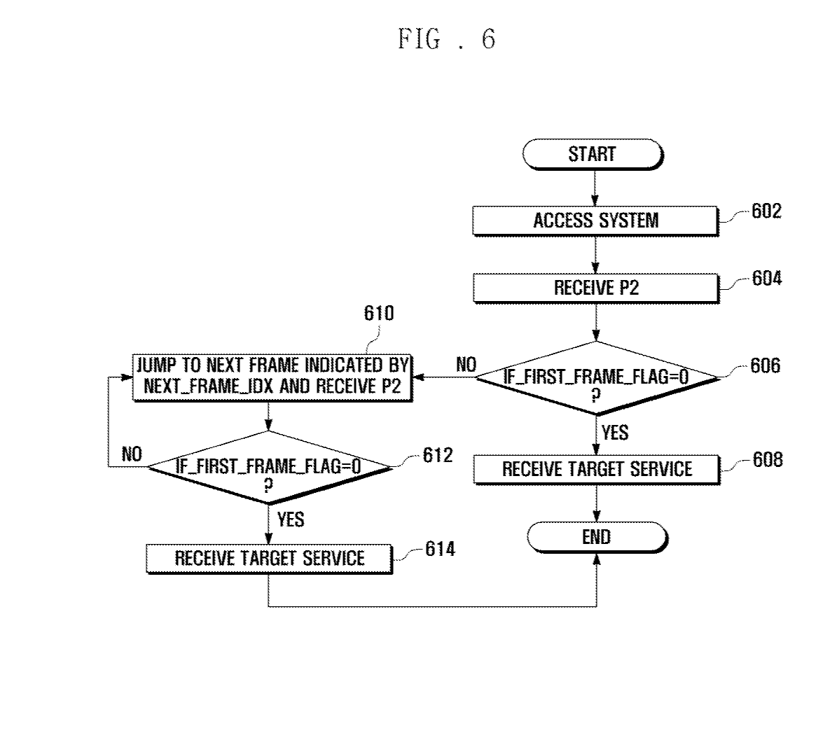

FIG. 6 is a flowchart illustrating an initial service access procedure of a broadcast receiver in a mobile broadcast system supporting the irregular interval broadcast service according to an exemplary embodiment of the present invention.

Referring to FIG. 6, the receiver first accesses the system in step 602 and receives the control information of a frame transmitted by the broadcast transmitter in step 604. Here, the control information can be the P2 preamble used in a DVB system. The P2 preamble, i.e., the control information, includes the next frame index (NEXT_FRAME_IDX) indicating the next frame carrying the current PLP (or the number of frames between the current frame and the next frame carrying the corresponding PLP) and the IF's frame flag (IF_FIRST_FRAME_FLAG) indicating whether the current frame is the first frame among the frames mapped to the IF.

Once the P2 preamble has been received, the receiver demodulates the P2 preamble and determines whether the IF_FIRST_FRAME_FLAG of the P2 preamble is set to 0 in step 606. If the IF_FIRST_FRAME_FLAG is set to 0, this means that the current frame is the first frame among the frames mapped to the IF and, otherwise if the IF_FIRST_FRAME_FLAG is set to 1, this means that the current frame is not the first frame among the frames mapped to the IF. If it has been determined that the IF_FIRST_FRAME_FLAG of the P2 is set to 0, the receiver demodulates the broadcast service traffic included in the current frame in step 608.

Otherwise, if it has been determined that the IF_FIRST_FRAME_FLAG of the P2 is set to 1, this means that the demodulation on the broadcast service traffic of the current is useless, and thus the receiver checks the NEXT_FRAME_IDX of the P2 preamble and receives the control information (P2 preamble) of the next frame indicated by the NEXT_FRAME_IDX in step 610. Next, the receiver checks the IF_FIRST_FRAME_FLAG of the P2 preamble and determines whether the IF_FIRST_FRAME_FLAG is set to 0 in step 612. If it has been determined that the IF_FIRST_FRAME_FLAG is set to 0, this means that the current frame is the first frame among the frames mapped to the IF and thus demodulates the broadcast service traffic of the frame in step 614. Otherwise, if it has been determined that the IF_FIRST_FRAME_FLAG is set to 1, the receiver repeats step 610 until the P2 preamble of which IF_FIRST_FRAME_FLAG is set to 0 is received.

As described above, when attempting to access the mobile broadcast system initially, the receiver receives a broadcast frame and extracts the next frame indicator and IF's frame flag related to the PLPs transmitted at an irregular interval from the broadcast frame, determines whether the current frame is the first frame among the frames mapped to the IF based on the IF's frame flag, receives, if the current frame is not the first frame of the IF, the next frame indicated by the next frame indicator, and demodulates, if the current frame is the first frame of the IF.

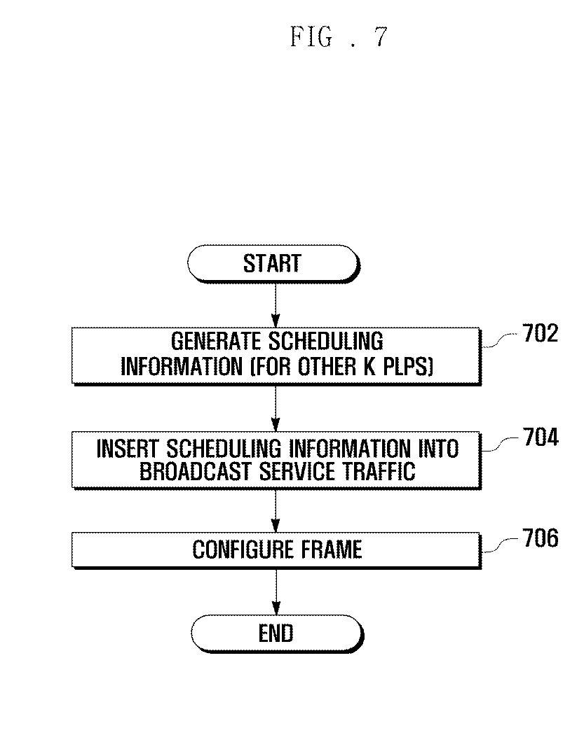

FIG. 7 is a flowchart illustrating an in-band signaling procedure of a transmitter for supporting channel switching in a mobile broadcast system supporting the irregular interval broadcast service according to an exemplary embodiment of the present invention.

Referring to FIG. 7, the transmitter generates the scheduling information about the K different PLPs multiplexed with their respective broadcast service traffics in step 702. The scheduling information is of the K PLPs including the PLPs transmitted at regular intervals and the PLPs transmitted at regular intervals in the corresponding frames following the current frame. The scheduling information includes the NEXT_FRAME_IDX in association with the PLPs transmitted at irregular intervals as described with reference to Table 2. That is, the transmitter inserts the control information about the PLPs that can be the target PLP in channel switching of the receiver into the current broadcast service traffic as the in-band signaling control information. Here, the in-band control information of the target PLP can include only the NEXT_FRAME_IDX or both the NEXT_FRAME_IDX and IF_FIRST_FRAME_FLAG as described above. The NEXT_FRAME_IDX is the next frame index indicating the next frame carrying the target PLP as in the P2 preamble of the current frame (or the number of frames between the current frame and the next frame carrying the target PLP). Each PLP can include its own scheduling information. After generating the scheduling information, the transmitter inserts the scheduling information of the target PLPs into the broadcast service traffics of the corresponding PLPs in step 704, and configures the frame by multiplexing the PLPs containing their own scheduling information into the frame in step 706.

The transmitter generates the control information of the PLPs, inserts the control information into the broadcast service traffic of the current PLP as in-band signaling, multiplexes the PLP having the control information into the frame. The transmitter also generates frame control information including the next frame indicator and the IF's frame flag of the PLPs transmitted at irregular intervals and multiplexes the broadcast service traffics and control information of the corresponding PLPs into frames. That is, the control information of the PLPs as the candidates for the channel switching is transmitted in the form of in-band signaling control information. In an exemplary embodiment of the present invention, the frame control information is inserted into the broadcast service traffic. When channel switching occurs, the receiver can recognize the location of the next frame carrying the target PLP by referencing the in-band control information included in the broadcast service traffic. The receiver jumps to the frame carrying target PLP and determines whether the frame is the first frame among the frames mapped to the IF. If the frame is the first frame among the frames mapped to the IF, the receiver performs demodulation on the broadcast service traffic of the frame.

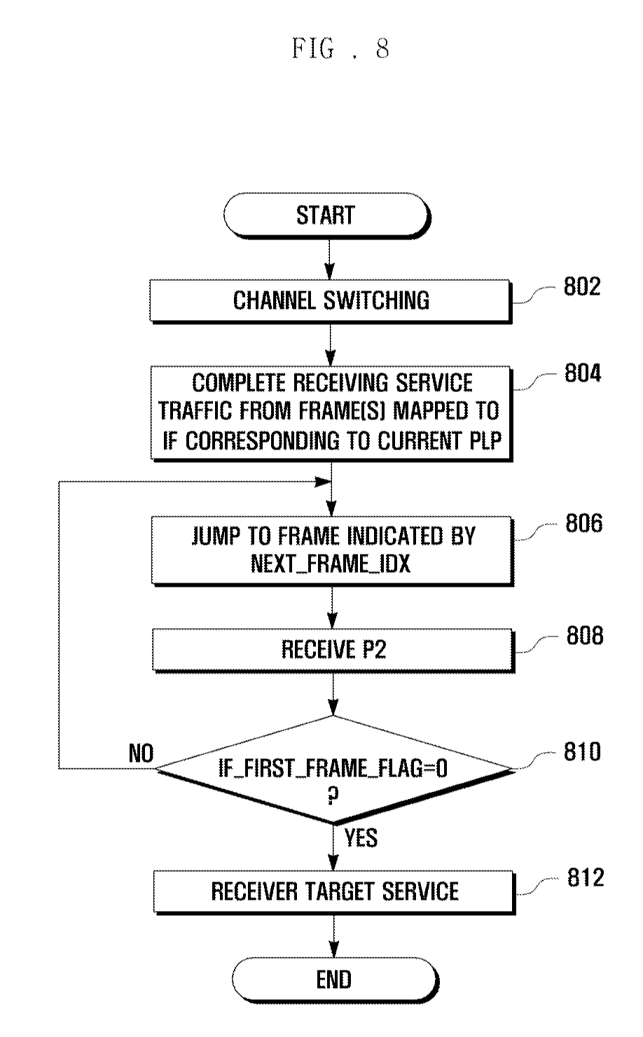

FIG. 8 is a flowchart illustrating a channel switching procedure of a receiver using the in-band signaling in a mobile broadcast system supporting the irregular interval broadcast service according to an exemplary embodiment of the present invention.

Referring to FIG. 8, the receiver first detects a channel switching event in step 8-02. If the channel switching event has been detected, the receiver continues receiving the signal to complete demodulation on the broadcast service traffic in the frame(s) mapped to the IF corresponding to the current frame in step 804. That is, the transmitter extracts the control information of the target PLP from the in-band signaling information included in the broadcast service traffic. Next, the receiver jumps to the frame indicated by the NEXT_FRAME_IDX of the control information acquired from the in-band signaling in step 806. Here, the NEXT_FRAME_IDX is the index indicating the next frame carrying the target PLP (or the number of frames between the current frame to the next frame carrying the target PLP), and the receiver jumps to the frame indicated by the NEXT_FRAME_IDX. Next, the receiver receives the frame indicated by the NEXT_FRAME_IDX and demodulates the control information (P2 preamble) of the frame in step 808 and determines whether the IF_FIRST_FRAME_FLAG of the control information acquired from the control information (P2 preamble) is set to 0 in step 810. If the IF_FIRST_FRAME_FLAG is set to 0, this means that the frame is the first frame among the frames mapped to the IF. Otherwise, if the IF_FIRST_FRAME_FLAG is set to 1, this means that the frame is not the first frame among the frames mapped to the IF. If it has been determined that the IF_FIRST_FRAME_FLAG is set to 0, the receiver receives the broadcast service traffic (target PLP) in the frame in step 812.

Otherwise, if it has been determined that the IF_FIRST_FRAME_FLAG is set to 1, the receiver repeats steps 806 to 810 until the frame of which control information (P2 preamble) has the IF_FIRST_FRAME_FLAG set to 0 is received. That is, the receiver jumps to the frame indicated by the NEXT_FRAME_IDX value of the control information (P2 preamble) demodulated through steps 806 and 808, demodulates the control information (P2 preamble), and then determines whether the IF_FIRST_FRAME_FLAG of the control information (P2 preamble) is set to 0. Steps 806 to 810 are repeated until the frame of which the IF_FIRST_FRAME_FLAG is set to 1 is received.

As described above, if the channel switching event has been detected, the receiver extracts the control information about the target PLP from the currently received frame and jumps to the frame carrying the target PLP. Next, the receiver extracts the control information about the target PLP from the frame carrying the target PLP and determines whether the current frame is the first frame among the frames mapped to the IF. If it has been determined that the current frame is the first frame among the frames mapped to the IF, the receiver demodulates the broadcast service traffic from the current frame. Otherwise, if it has been determined that the current frame is not the first frame among the frames mapped to the IF, the receiver receives the next frame carrying the target PLP repeatedly until the first frame corresponding to the current IF is received.

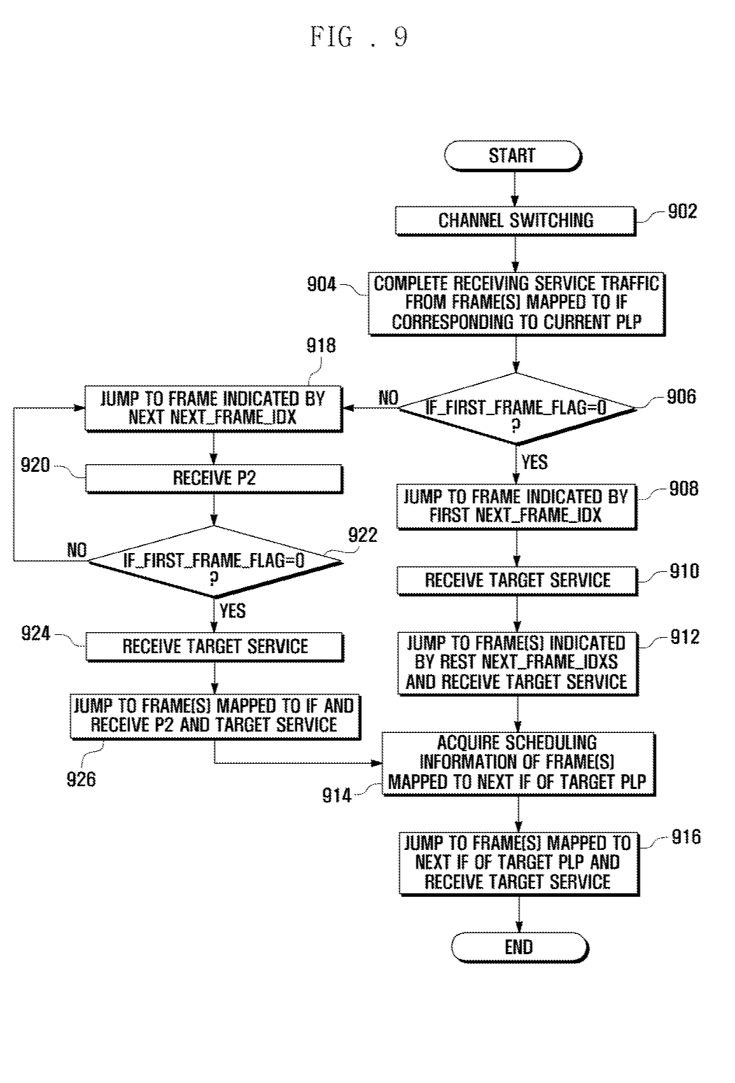

FIG. 9 is a flowchart illustrating a channel switching procedure of a receiver using the in-band signaling in a mobile broadcast system supporting the irregular interval broadcast service according to an exemplary embodiment of the present invention. In the case where the P_{I} of the target PLP is greater than 2, the in-band signaling for the current PLP represents the multiple scheduling information elements about the target PLP in the P_{I} frames after the channel switching. FIG. 9 is depicted under the assumption of P_{I}=2. In the case where the P_{I} is set to 1, steps 906 and 912 are omitted.

Referring to FIG. 9, the receiver first detects a channel switching event in step 902. If the channel switching event has been detected, the receiver continues receiving the signal to complete modulation on the broadcast service traffic in the frames mapped to the current IF corresponding to the current frame to acquire the control information about the target PLP transmitted in the broadcast service traffic in the form of an in-band signaling in step 904. Here, the control information about the target PLP includes the next frame index (NEXT_FRAME_IDX) for indicating the next frame carrying the target PLP (or the number of frames between the current frame and the next frame carrying the target frame) and the IF's frame flag (IF_FIRST_FRAME_FLAG) indicating whether the current frame is the first frame among the frames mapped to the IF. Next, the receiver determines whether the IF_FIRST_FRAME_FLAG of the control information acquired through the in-band signaling is set to 0 in step 906. If the IF_FIRST_FRAME_FLAG is set to 0, this means that the frame indicated by the first NEXT_FRAME_IDX is the first frame among the frames mapped to the IF of the target PLP, and thus the receiver jumps to the frame indicated by the first NEXT_FRAME_IDX in step 908 and receives the broadcast service traffic of the target PLP carried by the frame based on the control information acquired at step 904 in step 910.

As aforementioned, since the frame indicated by the first NEXT_FRAME_IDX is the first frame among the frames mapped to the single IF, the rest of the frames indicated by (P_{I}−1) NEXT_FRAME_IDX(s) must be received to acquire all the frames mapped to the IF. Accordingly, the receiver demodulates the broadcast service traffics of frames indicated by the NEXT_FRAME_IDX(s) in step 912. Through steps 908 to 912, the receiver receives the frames mapped to the signal IF and then acquires the location information and scheduling information about the P_{I} frames carrying the target PLP mapped to the next IF based on the in-signaling information in step 914. Next, the receiver jumps to the frames indicated by the control information acquired at step 914 and receives the broadcast service traffic of the target PLP carried by the frames at step 916.

If it has been determined, at step 906, that the IF_FIRST_FRAME_FLAG is set to 1, this means that the frame indicated by the first NEXT_FRAME_IDX is not the first frame among the frames mapped to the signal IF. Since the broadcast service traffic of a frame is useless without broadcast service traffic of the first frame among the frames mapped to the IF, the receiver ignores the frame indicated by the first NEXT_FRAME_IDX and jumps to the frame indicated by the next NEXT_FRAME_IDX in step 918 and demodulates control information (P2 preamble) of the frame in step 920. At this time, the control information (P2 preamble) of the frame is the preamble configured according to an exemplary embodiment of the present invention. Next, the receiver determines whether the IF_FIRST_FRAME_FLAG contained in the control information (P2 preamble) of the frame is set to 0 in step 922. If the IF_FIRST_FRAME_FLAG is set to 0, this means that the corresponding frame is the first frame among the frames mapped to the current IF. In this case, the receiver receives the broadcast service traffic of the target PLP carried by the corresponding frame in step 924. Since the location information of the next frame carrying the target PLP has been acquired from the control information (P2 preamble) at step 920, the receiver receives the next frame carrying the target PLP based on the control information and demodulates the control information (P2 preamble) and the broadcast service traffic from the corresponding frame in step 926. At this time, since the broadcast service traffic of the target PLP has been received from the first frame among the frames mapped to the current IF, the receiver continues demodulating the control information (P2 preamble) and the broadcast service traffic carried by the consecutive frames carrying the target PLP to the last frame mapped to the current IF. From the last frame mapped to the current IF, however, the receiver demodulates only the broadcast service traffic but not the control information (P2 preamble). As a consequence, the receiver can acquire the location and scheduling information for the frames mapped to the next IF at step 914.

If the IF_FIRST_FRAME_FLAG is set to 1, this means that the corresponding frame is not the first frame among the frames mapped to the current IF. In this case, the receiver repeats step 918 to check the next NEXT_FRAME_IDX and receive the frame indicated by the NEXT_FRAME_IDX. Steps 918 to 922 constitute the procedure for finding the first frame among the frames mapped to the single IF except for the firstly received frame (the firstly received frame has been excluded at step 906). This procedure is performed based on the fact that the first frame among the frames mapped to the IF exists among the P_{I} frames carrying the target PLP of which information has been acquired at step 904.

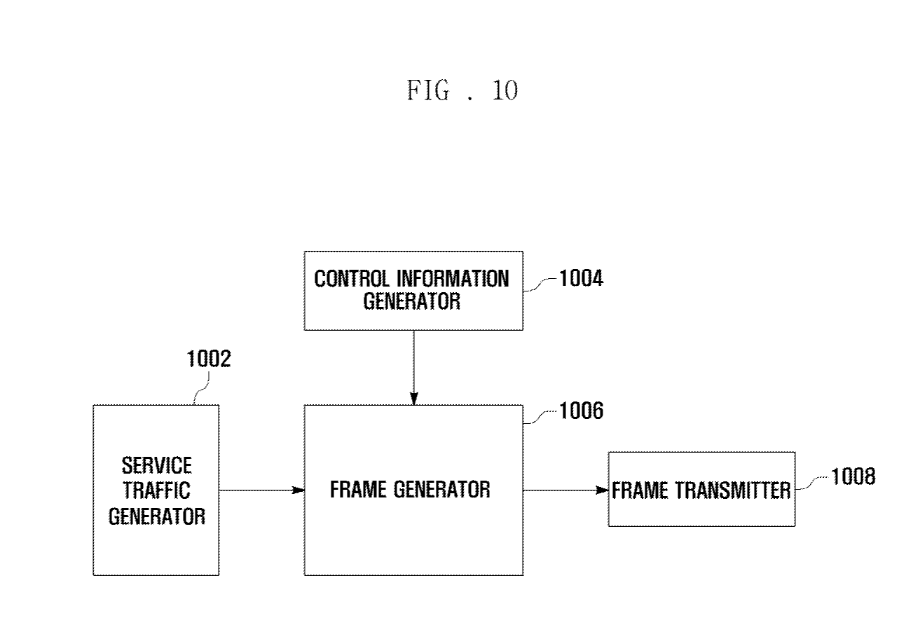

FIG. 10 is a block diagram illustrating a configuration of a transmitter for transmitting broadcast service traffic with control information (P2 preamble) in a mobile broadcast system supporting the irregular interval broadcast service according to an exemplary embodiment of the present invention.

As shown in FIG. 10, the transmitter includes a service traffic generator 1002, a control information generator 1004, a frame generator 1006, and a frame transmitter 1008.

The service traffic generator 1002 generates the broadcast service traffic to be broadcasted. The control information generator 1004 generates the control information including the scheduling information about the PLPs transmitted at regular intervals and the PLPs transmitted at irregular intervals. The control information generator 1004 can be the P2 signal generator for generating the P2 preamble. In an exemplary embodiment of the present invention, the P2 control information can include the location information of the next frame or the NEXT_FRAME_IDX indicating the location of the frame carrying the target PLP and the IF_FIRST_FRAME_FLAG indicating whether a frame is the first frame among the frames mapped to each IF. The frame generator 1006 generates the frames by multiplexing the control information (e.g., the P2 preamble) output by the control information generator 1004 and the broadcast service traffic output by the service traffic generator 1002 in the time domain. The frame transmitter 1008 transmits the frames output by the frame generator 1006.

In an exemplary embodiment of the present invention, the transmitter of the mobile broadcast system includes the service traffic generator 1002 for generating the broadcast service traffic, the control information generator 1004 for generating the control information about the PLPs transmitted at an irregular interval and including the next frame index and IF's frame flag, the frame generator 1006 for generating the frames by multiplexing the control information and the broadcast service traffic, and the frame transmitter 1008 for transmitting the frames generated by the frame generator 1006.

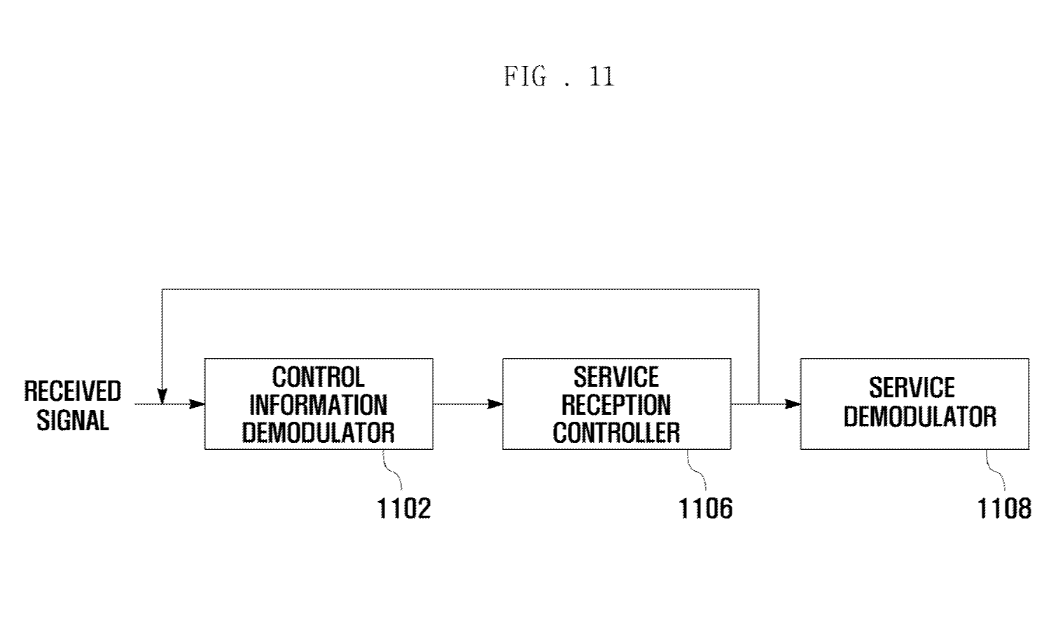

FIG. 11 is a block diagram illustrating a configuration of a receiver for receiving the broadcast service traffic with control information (P2 preamble) in a mobile broadcast system supporting the irregular interval broadcast service according to an exemplary embodiment of the present invention.

As shown in FIG. 11, the receiver includes a control information demodulator 1102, a service reception controller 1106, and a service demodulator 1108.

The control information demodulator 1102 performs demodulation on the control information of a frame started when the receiver initially accesses the system. Here, the control information can be the P2 frame of the DVB system. The control information demodulator 1102 can include a control information extractor for extracting the control information about the target PLP intended by a channel switching event from the demodulated control information (P2 signal). Here, the control information about the target PLP can include the next frame index (NEXT_FRAME_IDX) and the IF's frame flag (IF_FIRST_FRAME_FLAG). The service reception controller 1106 determines whether to receive the broadcast service traffic carried by the corresponding frame base on the IF_FIRST_FRAME_FLAG contained in the scheduling information of the target PLP. If the IF_FIRST_FRAME_FLAG is a value indicating that the corresponding frame is the first frame among the frames mapped to an IF, the service reception controller 1106 controls the service demodulator 1108 to demodulate the broadcast service traffic of the corresponding frame and, otherwise, controls the service demodulator to enter the idle mode. The service demodulator 1108 demodulates the broadcast service traffic carried by the frames under the control of the service reception controller 1106.

If a frame indicated as the first frame among the frames of the IF by the IF_FIRST_FRAME_FLAG of the control information has been detected, the service reception controller 1106 controls the service demodulator 1108 to modulate the broadcast service traffic of the corresponding frame. In the case where the frame which is not the first frame among the frames mapped to the IF, the service reception controller 1106 controls the control information demodulator to demodulate the control information (e.g. P2 preamble) of the frame indicated by the NEXT_FRAME_IDX.

The receiver structured as shown in FIG. 11 demodulates the control information proceeding the broadcast service traffic within a frame, determines whether the corresponding frame is the first frame among the frames mapped to the corresponding IF, performs demodulation on the broadcast service traffic if the corresponding frame is the first frame of the IF, and demodulates the control information (P2 signal) of the frame indicated by the NEXT_FRAME_IDX if the corresponding frame is not the first frame of the IF. That is, the service reception controller 1106 controls such that the receiver jumps to the next frame carrying the target PLP by referencing the NEXT_FRAME_IDX of the control information acquired by the control information demodulator 102 and the control information demodulator 1102 demodulates the control information in the frame indicated by the NEXT_FRAME_IDX. The control information checking process is repeated until the frame of which the IF_FIRST_FRAME_FLAG is set to 0 so as to receive the broadcast service traffic of the corresponding frame.

In an exemplary embodiment of the present invention, the receiver of the mobile broadcast system includes the control information demodulator 1102 which demodulates the control information proceeding the broadcast service traffic within a frame and extracts the next frame indicator and IF's first frame flag. The receiver of the mobile broadcast system also includes a service reception controller 1106 which determines whether the frame is the first frame among the frames mapped to an IF and controls to demodulate the broadcast service traffic if the frame is the first frame of the IF and waits until the frame which is the first frame of the IF is received if the frame is not the first frame. The receiver of the mobile broadcast system also includes a service demodulator 1108 which demodulates the broadcast service traffic of the frames under the control of the service reception controller 1106.

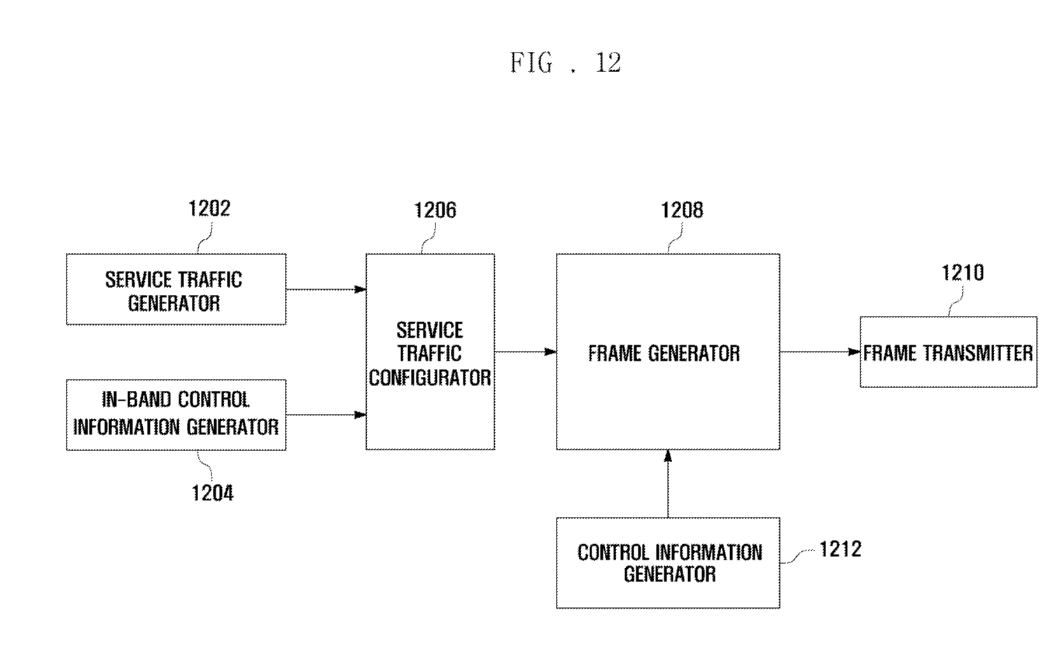

FIG. 12 is a block diagram illustrating a configuration of a transmitter for transmitting broadcast service traffic with in-band control information in a mobile broadcast system supporting the irregular interval broadcast service according to an exemplary embodiment of the present invention.

As shown in FIG. 12, the transmitter includes a service traffic generator 1202, an in-band control information generator 1204, a service traffic configurator 1206, a frame generator 1208, a frame transmitter 1210, and a control information generator 1212.

The service traffic generator 1202 generates the broadcast service traffic to be broadcasted. The broadcast service traffic can be composed of at least one base band Forward Error Control (FEC) frame. The in-band control information generator 1204 generates in-band control information about the PLPs. Here, the in-band control information about the PLPs can include only the NEXT_FRAME_IDX according to an exemplary embodiment of the present invention or both the NEXT_FRAME_IDX and IF_FIRST_FRAME_FLAG according to another exemplary embodiment of the present invention. The service traffic configurator 1206 multiplexes the broadcast service traffic and the control information about the PLPs. That is, the service traffic configurator 1206 multiplexes the broadcast service traffic and the control information about the PLPs so as to provide the in-band signaling control information. The service traffic configurator 1206 multiplexes the broadcast service traffic and the control information such that the control information about the PLPs is inserted into the padding part of the first baseband FEC frame of the broadcast service traffic.

The control information generator 1212 generates the control information about the PLPs transmitted at regular intervals and the PLPs transmitted at irregular intervals. Here, the control information generator 1212 can be a P2 signal generator for generating the P2 control information. The frame generator 1208 multiplexes the output of the service traffic configurator 1206 and the control information generated by the control information generator 1212 (e.g., P2 preamble) into the frames in the time domain. The frame transmitter 1210 transmits the frames generated by the frame generator 1208 over the air.

In an exemplary embodiment of the present invention, the control information (e.g., P2 signal) can include the NEXT_FRAME_IDX and the IF_FIRST_FRAME_FLAG as described above. In an exemplary embodiment of the present invention, the NEXT_FRAME_IDX generated by the in-band control information generator 1204 is the index indicating the next frame carrying the current PLP or the number of frames between the current frame and the next frame carrying the corresponding PLP. In an exemplary embodiment of the present invention, the NEXT_FRAME_IDX generated by the in-band control information generator 1204 is the location information about the P_{I} frames carrying the target PLP following the current frame, and the IF_FIRST_FRAME_FLAG is the flag indicating whether the first frame among the PI frames carrying the PLP and indicated by the NEXT_FRAME_IDX is the first frame among the P_{I} frames mapped to a single IF.

In an exemplary embodiment of the present invention, the transmitter of the mobile broadcast system transmitting the in-band signaling information for supporting the channel switching at the receiver receives the service traffic generator 1102 which generates the broadcast service traffic, an in-band control information generator 1204 which generates the control information about the candidate PLPs for the channel switching, the service traffic configurator 1206 which inserts the in-band control information into the broadcast service traffic, the control information including the NEXT_FRAME_IDX and IF_FIRST_FRAME_FLAG, the control information generator 1212 which generates the control information about the PLPs transmitted at regular intervals and the PLPs transmitted at irregular intervals, the frame generator 1208 which generates the frames by multiplexing the outputs of the service traffic configurator 1206 and the control information generator 1212, and the frame transmitter which transmits the frames generated by the frame generator 1208. The above structured transmitter generates the control information about the target PLP for the channel switching at the receiver, generates the frames by inserting the control information of the target PLP into the broadcast service traffic in the form of in-band signaling information, generates the control information containing the next frame indicator indicating the next frame carrying the PLPs transmitted at irregular intervals, multiplexes the broadcast service traffic of the corresponding PLPs and the control information into the frames, and transmits the frame.

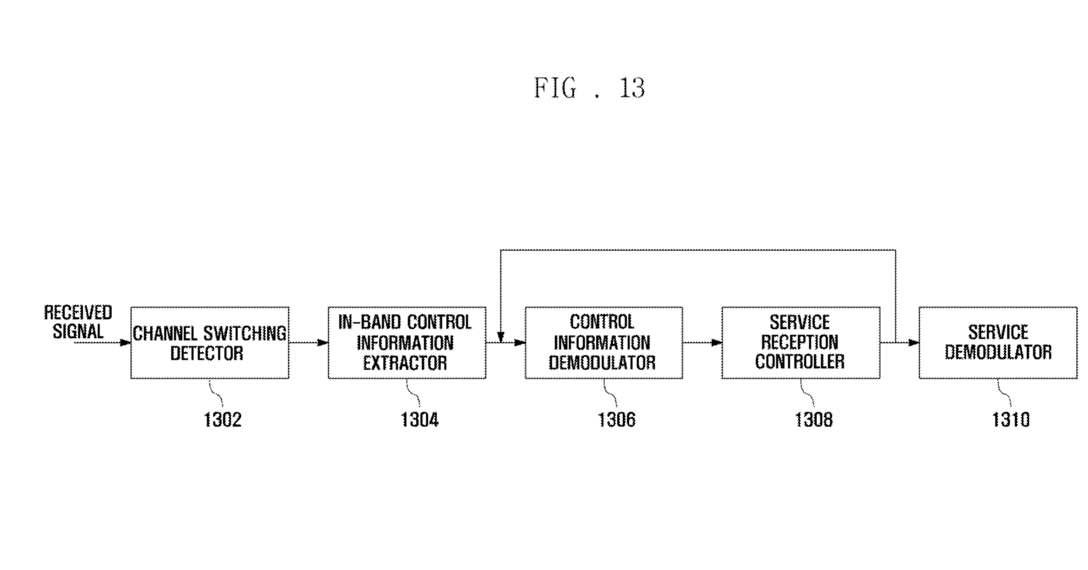

FIG. 13 is a diagram illustrating a configuration of a receiver for receiving the broadcast traffic with in-band control information in a mobile broadcast system supporting the irregular interval broadcast service according to an exemplary embodiment of the present invention.

As shown in FIG. 13, the receiver includes a channel switching detector 1302, an in-band control information extractor 1304, a control information demodulator 1306, a service reception controller 1308, and a service demodulator 1310.

If a channel switching event has occurred, the channel switching detector 1302 detects the channel switching event, and the in-band control information extractor 1304 demodulates all the frames mapped to the IF corresponding to the current PLP to extract in-band signaling information in the next frames carrying the target PLP indicated by the channel switching event. Here, the in-band signaling information extracted by the control information extractor 1304 includes the next frame index (NEXT_FRAME_IDX). The control information demodulator 1306 jumps to the next frame indicated by the NEXT_FRAME_IDX of the control information about the target PLP and demodulates the control information (e.g., P2 preamble) in the corresponding frame. The service reception controller 1308 checks the IF_FIRST_FRAME_FLAG included in the control information and determines whether to receive the broadcast service traffic included in the corresponding frame based on the value of the IF_FIRST_FRAME_FLAG. If the IF_FIRST_FRAME_FLAG is set to a value indicating the frame is the first frame among the frames mapped to a single IF, the service reception controller 1308 controls the service demodulator 1310 to demodulate the broadcast service traffic of the corresponding frame.

Otherwise, if the IF_FIRST_FRAME_FLAG is set to a value indicating the frame is not the first frame among the frames mapped to the IF, the service reception controller 1308 controls the control information demodulator 1306 to jump to the next frame carrying the target PLP. That is, the control information demodulator 1306 jumps to the next frame carrying the target PLP by referencing the NEXT_FRAME_IDX of the control information demodulated previously and performs control information demodulation in the jumped frame. As aforementioned, the service reception controller 1308 determines whether to receive the broadcast service traffic of the corresponding frame base on the IF_FIRST_FRAME_FLAG value of the control information demodulated by the control information demodulator 1306. The control information demodulation is repeated until the first frame among the frames mapped to the IF is received.

In an exemplary embodiment of the present invention, the receiver of the mobile broadcast system includes the channel switching detector 1302 which detects the channel switching event. The receiver of the mobile broadcast system also includes the in-band control information extractor 1304 which demodulates the broadcast service traffic of the frame containing the control information about the target PLP of the channel switching and extracts the control information about the target PLP from the demodulated broadcast service traffic. The receiver of the mobile broadcast system further includes the control information demodulator 1306 which jumps to the frame carrying the target PLP and indicated by the next frame index of the control information extracted by the in-band control information extractor 1304 and demodulates the next frame index and IF's first frame flag from the control information contain in the jumped frame. The receiver of the mobile broadcast system further includes the service reception controller 1308 which determines whether to demodulate the broadcast service traffic carried by the frame based on the IF's first frame flag value. The receiver of the mobile broadcast system also includes the service demodulator 1310 which demodulates the broadcast service traffic carried by the frame under the control of the service reception controller 1308.

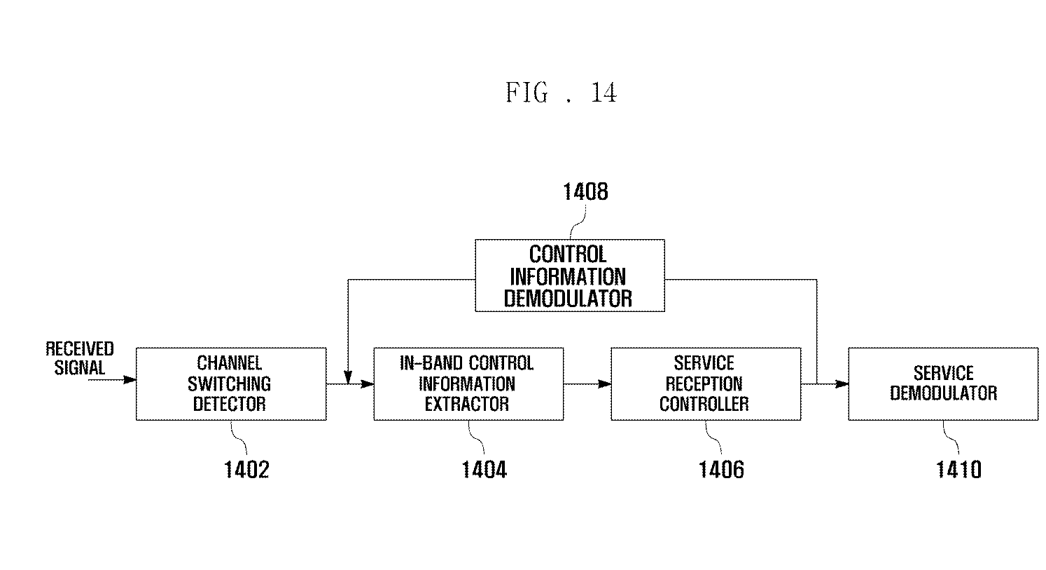

FIG. 14 is a block diagram illustrating a configuration of a receiver for receiving the broadcast traffic with in-band control information in a mobile broadcast system supporting the irregular interval broadcast service according to an exemplary embodiment of the present invention. A description is made under the assumption of P_{I}=2.

Referring to FIG. 14, the receiver includes a channel switching detector 1402, an in-band control information extractor 1404, a service reception controller 1406, a control information demodulator 1408, and a service demodulator 1410.

If a channel switching event has occurred, the channel switching detector 1402 detects the channel switching event and activates the in-band control information extractor 1404. The in-band control information extractor 1404 performs demodulation on the frames carrying the current PLP and mapped to a single IF to extract the in-band signaling information related to the location and scheduling about the next frames carrying the target PLP. Here, the in-band signaling control information includes the IF_FIRST_FRAME_FLAG and NEXT_FRAME_IDX. The service reception controller 1406 determines whether to receive the corresponding frame based on the value of the IF_FIRST_FRAME_FLAG of the in-band signaling control information about the target PLPs extracted by the in-band control information extractor 1404. If the IF_FIRST_FRAME_FLAG is set to a value indicating that the frame is the first frame among the frames mapped to the IF, the service reception controller 1406 controls the service demodulator 1410 to demodulate the broadcast service traffic carried by the corresponding frame.

Otherwise, if the IF_FIRST_FRAME_FLAG is set to a value indicating that the frame is not the first frame among the frames mapped to the IF, the service reception controller 1406 controls the control information demodulator 1408 to jump to the next frame carrying the target PLP. The control information demodulator 1408 jumps to the next frame carrying the target PLP by referencing the next NEXT_FRAME_IDX of the in-band signaling control information extracted by the in-band control information extractor 1404 and demodulates the control information (e.g., P2 signal) in the corresponding frame. The in-band control information extractor 1404 extracts the control information of the target PLP from the control information (P2 signal) acquired by the control information demodulator 1408, and the service reception controller 1406 determines whether to receive the broadcast service traffic in the corresponding frame base on the IF_FIRST_FRAME_FLAG value of the control information. The control information demodulation is repeated until the first frame among the frames mapped to the IF is received.

In the case where the P_{I} is set to 2, the first frame of among the frames mapped to the IF carrying the target PLP corresponds to the second frames of P_{I} frames indicated by the in-band signaling. Accordingly, the service reception controller 1406 can detect the IF_FIRST_FRAME_FLAG set to 0 in the second P2 demodulation signal. If the IF_FIRST_FRAME_FLAG set to 0 has been detected, the service reception controller 1406 controls the service demodulator 1410 to demodulate the broadcast service traffic of the target PLP.

As described above, the mobile broadcast system supporting irregular broadcast service according to exemplary embodiments of the present invention allows the receiver to detect the accurate timing for demodulating available broadcast service traffic of a target PLP, thereby minimizing power consumption of the receiver and switching between service channels efficiently.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A control information delivery method for a mobile broadcast system, the method comprising:
generating scheduling information of Physical Layer Pipes (PLPs) transmitted at irregular intervals, the scheduling information including a next frame index and a first frame flag;
inserting the scheduling information into control information of a current frame; and
multiplexing broadcast service traffic of the PLPs and the control information.

2. The method of claim 1, wherein the control information comprises a P2 preamble, the next frame index comprises an index of the next frame carrying the corresponding PLP or a number of frames between the current frame and the next frame carrying the corresponding PLP, and the first frame flag comprises a flag indicating whether the frame is a first frame among the frames carrying the corresponding PLP.

3. The method of claim 2, wherein the broadcast service traffic comprises the broadcast service traffic of the current PLP and comprises the control information of a target PLP for channel switching.

4. The method of claim 3, wherein the control information of the target PLP comprises the next frame index indicating the next frame carrying the target PLP or a number of frames between the current frame and the next frame carrying the target PLP.

5. The method of claim 3, wherein the control information of the target PLP comprises the control information of the target PLP, comprises the next frame index indicating the next frame carrying the target PLP or a number of frames between the current frame and the next frame carrying the target PLP, and comprises the first frame flag indicating whether the frame is a first frame among the frames carrying the corresponding PLP.

6. The method of claim 2, further comprising:
receiving, at a receiver, the frame;
extracting the control information from the received frame;
repeating, if the first frame flag of the control information is set to a value indicating that the frame is not the first frame, receiving the next frame indicated by the next frame; and
processing, if the first frame flag of the control information is set to a value indicating that the frame is the first frame, the broadcast service traffic in the corresponding frame.

7. The method of claim 3, further comprising:
receiving, at a receiver, the frame;
extracting the control information of the target PLP from the received frame;
jumping to a frame carrying the target PLP based on the control information;
extracting the control information from the frame;
checking the first frame flag contained in the control information;
repeating, if the first frame flag of the control information is set to a value indicating that the frame is not the first frame, receiving the next frame indicated by the next frame; and
processing, if the first frame flag of the control information is set to a value indicating that the frame is the first frame, the broadcast service traffic in the corresponding frame.

8. A system access method of a receiver in a mobile broadcast system, the method comprising:
receiving a frame carrying broadcast service traffic;
extracting control information from the frame, the control information including a next frame index and an initial frame flag;
analyzing the initial frame flag;
jumping, if the frame is not the initial frame based on the analysis result, to a next frame indicated by the next frame index to analyze the initial frame flag; and
processing, if the frame is the initial frame based on the analysis result, the broadcast service traffic in the frame.

9. The method of claim 8, wherein the control information comprises a P2 preamble, the next frame index comprises an index of the next frame carrying the corresponding PLP or a number of frames between the current frame and the next frame carrying the corresponding PLP, and the initial frame flag comprises a flag indicating whether the frame is a first frame among the frames carrying the corresponding PLP.

10. The method of claim 9, wherein the frame comprises broadcast service traffic and control information.

11. The method of claim 10, wherein the broadcast service traffic comprises in-band signaling control information of a target PLP for channel switching, further comprising:
receiving the next frame transmitted after the channel switching;
jumping to a frame carrying the target PLP based on the control information of the target frame which is extracted from the received frame;
extracting the control information from the received frame;
repeating, if the frame is not the initial frame based on the initial frame flag of the control information, receipt of next frame indicated by the next frame index of the control information; and
processing, if the frame is the initial frame based on the analysis result, the broadcast service traffic in the frame.

12. A control information delivery method for a mobile broadcast system, the method comprising:
generating in-band control information of Physical Layer Pipes (PLPs) for channel switching;
multiplexing broadcast service traffic of a current PLP and the in-band control information into a frame;
generating control information including a next frame index and an initial frame flag for the PLPs transmitted at irregular intervals;
multiplexing the broadcast service traffic of the PLPs and the control information into the frame; and
transmitting the frame.

13. The method of claim 12, wherein the control information comprises a P2 preamble, the next frame index comprises an index of the next frame carrying the corresponding PLP or a number of frames between the current frame and the next frame carrying the corresponding PLP, and the initial frame flag comprises a flag indicating whether the frame is a first frame among the frames carrying the corresponding PLP.

14. The method of claim 13, wherein the control information of a target PLP for the channel switching comprises the next frame index indicating a next frame carrying the corresponding PLP or a number of frames between the current frame and the next frame carrying the corresponding PLP.

15. The method of claim 13, wherein the control information of a target PLP for the channel switching comprises the next frame index indicating the next frame carrying the target PLP or a number of frames between the current frame and the next frame carrying the target PLP and the initial frame flag indicating whether the frame is an initial frame among the frames carrying the corresponding PLP.

16. The method of claim 13, further comprising:
receiving, at a receiver, the frame;
extracting the control information from the received frame;
jumping to the frame carrying the target frame;
extracting the control information from the jumped frame;
repeating, if the initial frame flag of the control information is set to a value indicating that the frame is not the first frame, receiving the next frame indicated by the next frame; and
processing, if the initial frame flag of the control information is set to a value indicating that the frame is the frame, the broadcast service traffic in the corresponding frame.

17. A mobile broadcast system comprising a transmitter and a receiver, wherein the transmitter comprises:
a service traffic generator for generating broadcast service traffic;
a control information generator for generating control information of Physical Layer Pipes (PLPs) transmitted at irregular intervals, the control information including a next frame index and an initial frame flag;
a frame generator for generating frames by multiplexing the broadcast service traffic of the PLPs and the control information; and
a frame transmitter for transmitting the frames.

18. The system of claim 17, wherein the control information comprises a P2 preamble, the next frame index comprises an index of the next frame carrying the corresponding PLP or a number of frames between the current frame and the next frame carrying the corresponding PLP, and the initial frame flag comprises a flag indicating whether the frame is an initial frame among the frames carrying the corresponding PLP.

19. The system of claim 18, wherein the receiver comprises:
a control information demodulator for demodulating the control information in the frame to extract the next frame index and the initial frame flag;
a service reception controller for checking the initial frame flag, for waiting until the control information demodulator demodulates a next frame indicated by the next frame index if the frame is not an initial frame among the frames carrying the corresponding PLP, and for controlling demodulation of the broadcast service traffic in a frame that is indicated by the initial frame flag as the initial frame among the frames carrying the corresponding PLP; and
a service demodulator for demodulating the broadcast service traffic under the control of the service reception controller.
